(19) United States
(12) Patent Application Publication
(10) Pub. No.: US 2026/0104109 A1
(43) Pub. Date: Apr. 16, 2026

(54) A POLYMER F-CLIPS

(71) Applicant: SERDAR PLASTIK, Sincan/Ankara (TR)

(72) Inventor: Mustafa Serdar TUTEK, Sincan/Ankara (TR)

(73) Assignee: SERDAR PLASTIK, Sincan/Ankara (TR)

(21) Appl. No.: 19/114,472

(22) PCT Filed: Sep. 22, 2023
(86) PCT No.: PCT/TR2023/051013

§ 371 Date: Mar. 24, 2025

(30) Foreign Application Priority Data
Sep. 23, 2022 (TR) 2022/014677

(51) Int. Cl. F16L 3/13; F16L 3/237

(52) U.S. Cl. CPC F16L 3/13; F16L 3/237

(57) ABSTRACT

The clip that is the subject of the invention is characterized in that it is a one-piece, lockless connection clip with a “C” shape to group and fix all components and hydraulic elements that are suitable for the mounting structure of the clip and need to be fixed to each other in washing, cleaning and similar systems in hydraulic systems working with pressurised and hot/cold water, such as combi boilers/floor heaters, etc., is capable of grasping the flanges of the hydraulic parts it connects radially with its “C” shaped structure, can withstand the pressure, temperature and tension it is exposed to, can be coloured and is made of thermoplastic polymer raw materials.

The invention is a lockless connection clip made of thermoplastic polymer raw material, that is used at the connection points of hydraulic elements in hydraulic systems working with pressurised and hot water, such as combi boilers/floor heaters, etc., can radially grip the flanges of the hydraulic parts it connects to each other and withstand the pressure, temperature, and tension it is exposed to with its special geometric structure. The invention relates to a corrosion and oxidation resistant thermoplastic polymer one-piece “C” shaped clip, which can be easily grouped and disassembled with one hand, in order to fix two components suitable for assembly together in said systems.

### TECHNICAL FIELD OF THE INVENTION

The subject of the invention is a connection lock used at the connection points of hydraulic elements in hydraulic systems operating with pressurised and hot water, such as combi boilers/floor heaters. It ensures that the system operates as a whole and smoothly by preventing the sealing passage points between the hydraulic elements from being separated from each other.

### STATE OF THE ART

The vast majority of existing techniques using this invention are metal connection locks. Since their areas of use are mostly hydraulic water systems, they are susceptible to ageing effects such as corrosion/rust over time. This situation creates vulnerability to fixing and sealing problems at the junction/grouping points. In order to be protected from these, they must be subjected to 2nd coating operations. Since this invention is manufactured from Thermoplastic Polymer raw materials, it does not contain the risk of corrosion and rust that exist in the state of the art, and it differs from existing technology because it does not require 2nd operations and is a production process more prone to the mass production methodology.

### BRIEF DESCRIPTION OF THE INVENTION

The clip that is the subject of the invention is characterized in that it is a one-piece, lockless connection clip with a “C” shape to group and fix all components and hydraulic elements that are suitable for the mounting structure of the clip and need to be fixed to each other in washing, cleaning and similar systems in hydraulic systems working with pressurised and hot/cold water, such as combi boilers/floor heaters, etc., is capable of grasping the flanges of the hydraulic parts it connects radially with its “C” shaped structure, can withstand the pressure, temperature and tension it is exposed to, can be coloured and is made of thermoplastic polymer raw materials.

Our invention is a lockless clip that has a corrosion-resistant thermoplastic polymer body and a “C” shaped claw end structure (4) that facilitates its mounting to the area where it is connected and can grasp completely and can be easily grouped and disassembled with one hand. With this innovative structure, it is characterized by being a simpler and more useful clip than other known clip structures in the field.

### DETAILED DESCRIPTION OF THE INVENTION

The invention is a lockless connection clip, unlike the state of the art, made of thermoplastic polymer raw materials, which is used at the connection points of hydraulic elements in hydraulic systems working with pressurised and hot water, such as combi boilers/floor heaters, etc. and can withstand the pressure, temperature, and tensions it is exposed to with its special geometric structure. With this feature, it is fully protected against corrosion and rust without the need for a secondary operation such as any coating etc. With this feature, the effects of temperature, humidity, hydrolysis, and similar variations are kept to a minimum level.

### BRIEF DESCRIPTION OF THE DRAWINGS

FIG. 1—SerkoFlow Polymer F-Clip Front

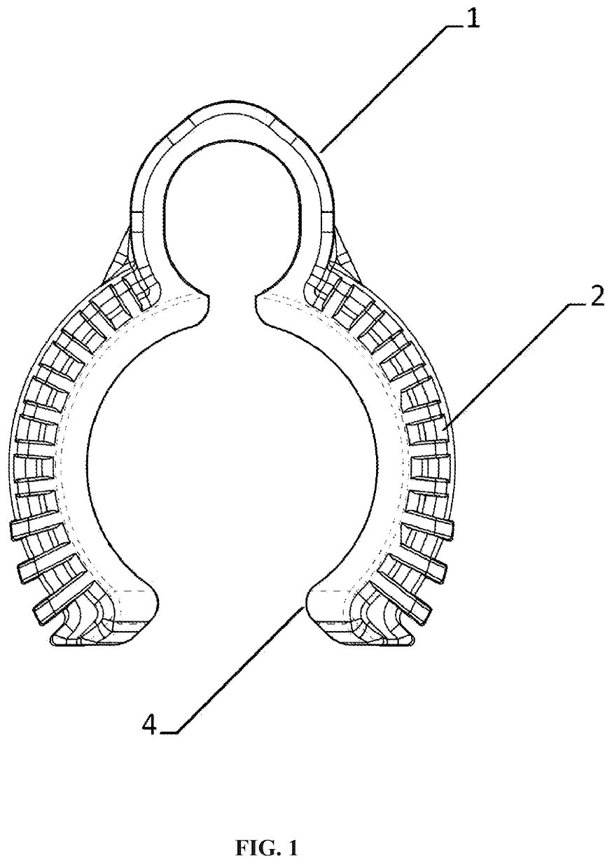

FIG. 2—SerkoFlow Polymer F-Clip Rear

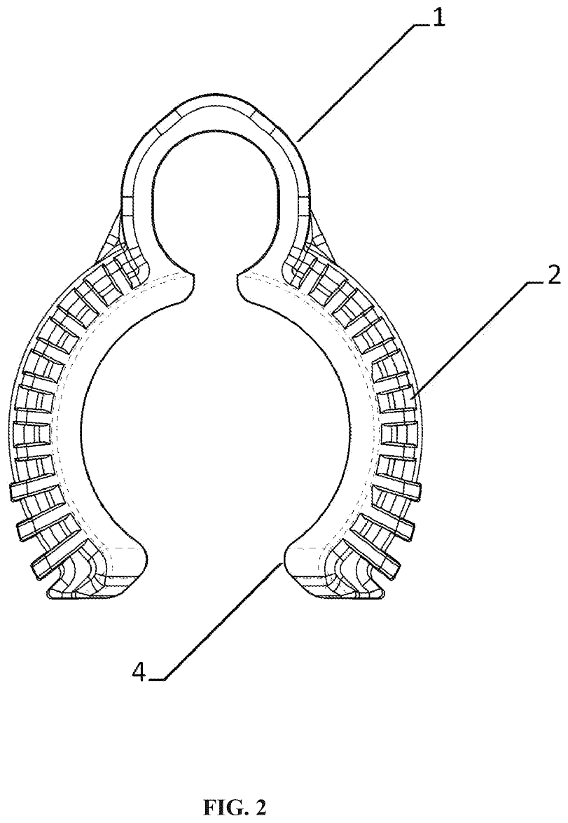

FIG. 3—SerkoFlow Polymer F-Clip Side

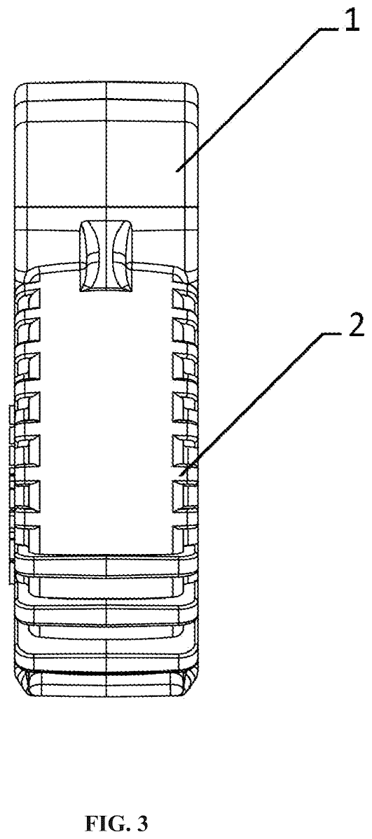

FIG. 4—SerkoFlow Polymer F-Clip Section

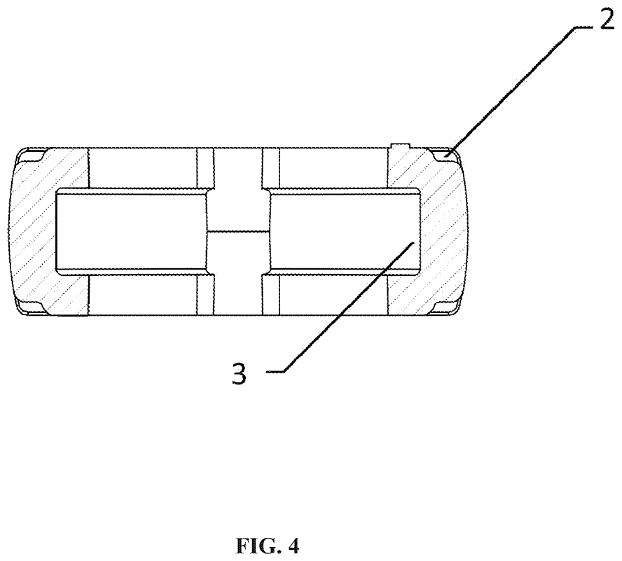

FIG. 5—SerkoFlow Polymer F-Clip Front Perspective

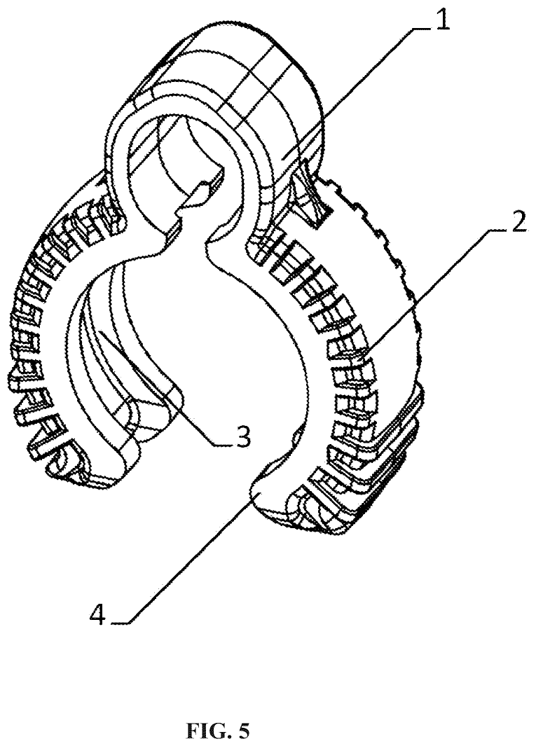

FIG. 6—SerkoFlow Polymer F-Clip Rear Perspective

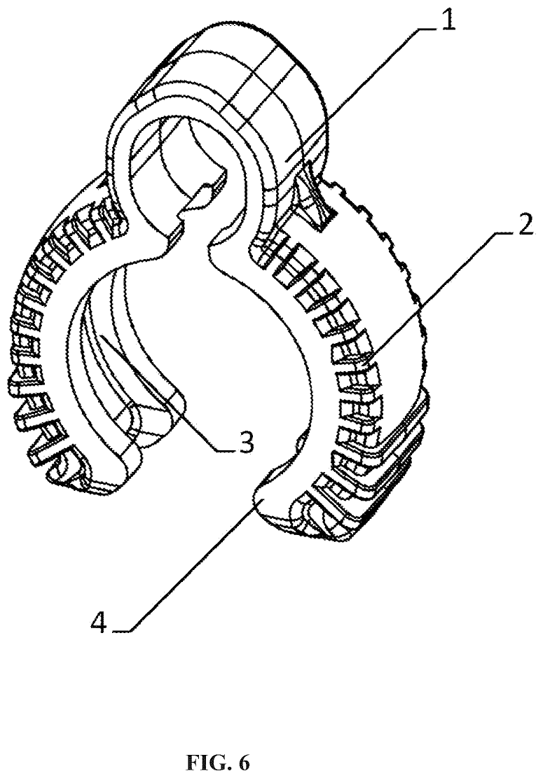

FIG. 7—SerkoFlow Polymer F-Clip Bottom Perspective

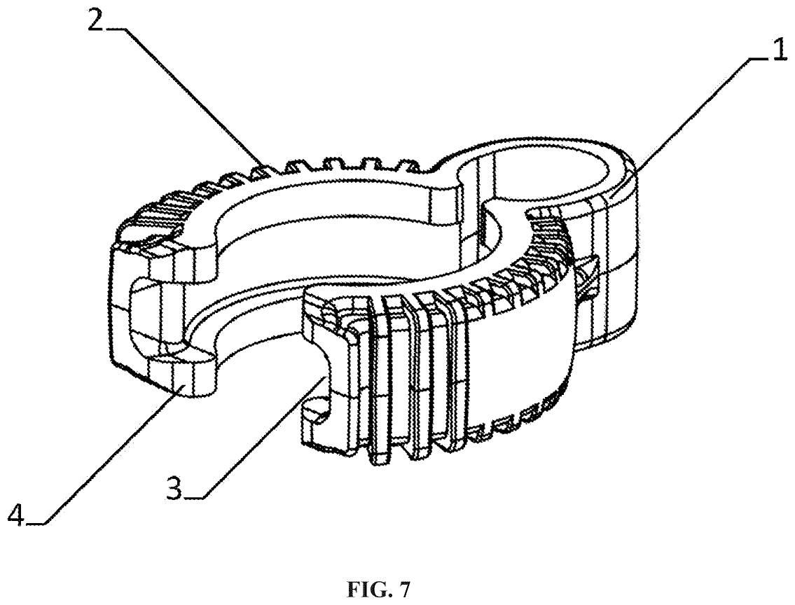

### REFERENCES

1—Flexible flange
2—Ribbed core
3—Recess
4—Claw end structure

The fact that it is manufactured from thermoplastic polymer raw materials has made it a more resistant, durable, and long-lasting product than the known structures in the field. It is characterized in that it can be produced in different colours depending on customer and market expectations and to identify the pipe types being installed, and that it has a structure produced without a moving core that can be flexed out of the mould by means of its claw end structure (4).

The invention is defined by the production of a single piece with thermoplastic polymer raw material. Since it is manufactured in one piece, it does not comprise any screws or joint connections. It is connected to the connection points that require sealing by stretching and grasping the flanges of the hydraulic elements radially. By means of its “C” shape, it resists the pressure and temperature values of the system in the direction of separation and prevents separation and opening. The invention is defined by its ribbed core (2) structure and a “C” profile section, which will resist the separation of the hydraulic equipment it connects from each other. It provides this pressure and temperature resistance by means of its ribbed core (2) structure, which resists the separation of the hydraulic elements. It is characterized in that its upper part has a flexible flange (1) shape, that it can be mounted by being flexible, that it has a lockless structure, and that the hydraulic elements it combines cannot be separated with its “C” profile section structure.

The clip that is the subject of the invention can be defined by the fact that its tips (claws) (4) in the installation direction can be easily replaced with specially shaped chamfers. By means of its convenient shaping, it has a lockless shape that can be easily assembled and disassembled with one hand without the need for any other tools.

It is defined as the connection part of hydraulic elements produced from thermoplastic polymer raw material, which is flexible in the direction of assembly and has a rigid structure in the direction of strength. At the same time, the shape of the invention does not have any sharp structure so as not to harm the human hand during disassembly and assembly, all edge parts are designed with radius. By means of this design, it is defined as having a shape that can be easily assembled and disassembled with one hand, without the need for any other tools. With its innovative shape, it is characterized in that it is a simpler and more useful clip than other known clip structures in the field.

The invention, which is a pipe clip assembly, is characterized in that it is a high-strength, flexible clip for assembly, with a claw end structure (4) on its outer surface and radius ribs shaped parallel to the body structure at the comer points, has specially shaped recesses (3) on its inner surface to perfectly lock the smaller diameter pipes passing through it to each other and prevent them from being separated.

What is claimed is:

1. A “C” shaped lockless connection clip used at the connection points of hydraulic elements in hydraulic systems operating with pressurised and hot water, such as combi boilers/room heaters etc., characterised in that it is a lockless connection clip made of thermoplastic polymer raw material in a C” shape.

2. A “C” shaped lockless connecting clip according to claim 1, characterised in that it is made of thermoplastic polymer raw material, has a rigid structure in the direction of strength by means of its flexible ears (1) that stretch in the direction of assembly, and is the connection part of hydraulic elements.

3. A “C” shaped lockless connecting clip according to claim 1, characterised in that it has a “C” profile section with a ribbed core (2) structure to provide resistance to the separation of the hydraulic equipment it connects from each other.

4. A “C” shaped lockless connecting clip according to claim 1, characterised in that it is mounted by stretching, with its upper part shaped like a flexible flange (1), does not require a lock, has a lockless structure by means of its “C” profile section structure, flexible flange (1), recess (3) and clawed end structure (4) and ensures that the hydraulic elements cannot be separated.

5. A “C” shaped lockless connecting clip according to claim 1, characterised in that it has a structure that can be assembled and disassembled by hand without the need for a tool by means of the fact that all edge parts have a radius.

6. A “C” shaped lockless connecting clip according to claim 1, characterised in that it can be produced in different colours to identify the pipe types being installed and has a structure that can be produced without a movable core that can be stretched out of the mould.

7. A “C” shaped lockless connecting clip according to claim 1, characterised in that, as a pipe clip assembly, it is a high-strength, flexible clip for assembly, with a claw end structure (4) on its outer surface and radius ribs shaped parallel to the body structure at the corner points, has specially shaped recesses (3) on its inner surface to perfectly lock the smaller diameter pipes passing through it to each other and prevent them from being separated.
